(19) United States
(12) Patent Application Publication
(10) Pub. No.: US 2025/0002773 A1
(43) Pub. Date: Jan. 2, 2025

(54) POLYKETONE RESIN BLEND WITH COLORANT

(71) Applicants: Russel MOORE, Drayton Valley (CA); Beau LOHRER, Casper, WY (US)

(72) Inventors: Russel MOORE, Drayton Valley (CA); Beau LOHRER, Casper, WY (US)

(21) Appl. No.: 18/732,582

(22) Filed: Jun. 3, 2024

Related U.S. Application Data
(60) Provisional application No. 63/470,453, filed on Jun. 2, 2023.

(51) Int. Cl. C09K 8/532; E21B 41/02

(52) U.S. Cl. CPC C09K 8/532; E21B 41/02

(57) ABSTRACT

An extrudable polyketone material consisting essentially of a polyketone resin blended with a polyketone-resin-based coloring agent, with the coloring agent content of the material being in the range of approximately 1% to approximately 2.5% by weight, exhibits improved resistance to tensile fracture in sub-freezing-point conditions, relative to the polyketone resin without the coloring agent. In some embodiments, the coloring agent content of the polyketone material is approximately 2.0% by weight.

### FIELD

The present disclosure relates in general to materials for lining oilfield tubulars for protection against corrosion, and relates in particular to liner materials that can withstand high operating temperatures, while also providing liners with good cold-weather performance capabilities.

### BACKGROUND

It is well known to line oilfield tubulars such as steel production tubing with plastic materials (e.g., high-density polyethylene, or HDPF) to protect the steel tubing's inner bore surfaces against corrosion from wellbore fluids (for example, in “sour” gas wells containing high levels of hydrogen sulfide). Individual lengths (or “joints”) of tubing (often so-called “upset” tubing) are commonly lined for this purpose by inserting a tubular plastic liner into the bore of a tubing joint, with the plastic liner having an outside diameter slightly smaller than the inside diameter of the tubing joint, and with the liner extending a selected distance beyond each end of the tubing joint. This assembly is then heated in an oven, causing both the tubing joint and the liner to expand longitudinally, to a temperature at which the liner material (which is typically a thermoplastic material) is soft enough to be readily moldable. At that stage, the heated assembly is placed in an apparatus configured to apply axial compression to the liner causing the liner ends to deform around the ends of the liner around the ends of the tubing joint, forming annular flanges extending radially outward over the tubing joint wall. The assembly is then cooled to ambient temperature.

Due to differences in the coefficients of expansion of the steel tubing and the plastic liner material, the cooling process induces axial tension in the liner, such that the annular flanges formed on the ends of the liner compressively engage the ends the tubing joint, thus positively retaining the liner axially within the tubing joint, and at the same time ensuring that the steel of the tubing joint will not be exposed to wellbore fluids when the joint is incorporated into a string of similar lined tubing joints.

Materials used for lining oilfield tubulars typically require resistance to high operating temperatures often encountered in deep oil and gas wells. The production string in a producing well periodically needs to be pulled out of the well by a service rig to enable servicing of the well for maintenance purposes or to remedy unanticipated downhole problems. In the common case where a well having lined production tubing is in production in cold winter conditions (such as in northern Canada, and in northern U.S. states including North Dakota, Wyoming, and others), the liners of tubing joints pulled out of hot deeper zones of the well by a service rig can experience thermal shock as they cool from high downhole temperatures (e.g., 250° to 350° F., or 120° to 175° C.) to ambient surface temperatures that can be as low as −32° F. (−35° C.).

In such cold weather conditions, the difference between the downhole and surface temperatures will tend to induce axial tension expansion of the in the liners of lined tubing joints being pulled out of a well, because the liners are not free to axially contract in response to the temperature change (as they would if not axially constrained by their end flanges), and because the steel tubing has a lower coefficient of expansion than the liner material. Unless the liners are pulled from the well at a slow enough rate to prevent thermal shock, sudden tensile failure of the liners can occur and cause the liners' end flanges to break off, thus rendering the lined tubing joint no longer serviceable and needing to be relined.

Another observed phenomenon is that liner flanges are prone to breaking off due to tensile failure while in storage at a wellsite when the ambient surface temperature drops below the freezing point, particularly in the range of 0° F. and −20° F. (−18° C. and −29° C.), in which liner flange breakage rates of 60-70% have been observed for polyketone liners in steel tubing joints having outside diameters of 2.875 inches and 3.5 inches. This phenomenon can be best understood with reference to FIGS. 1, 2, and 3, described below.

### BRIEF DESCRIPTION OF THE DRAWINGS

FIG. 1 is a side view of a prior art “upset” oilfield tubular having upset ends.

FIG. 2 is 1 is a partial section through one end of the upset oilfield tubular shown in FIG. 1, illustrating a longitudinal bore extending the length of the tubular.

FIG. 3 illustrates an upset oilfield tubular generally as shown in FIGS. 1 and 2, but having a polymeric liner extending through the longitudinal bore of the tubular.

### DESCRIPTION

The present disclosure teaches new polyketone resin blends, as well as tubular liners made from these materials for lining oilfield tubulars such as production tubing.

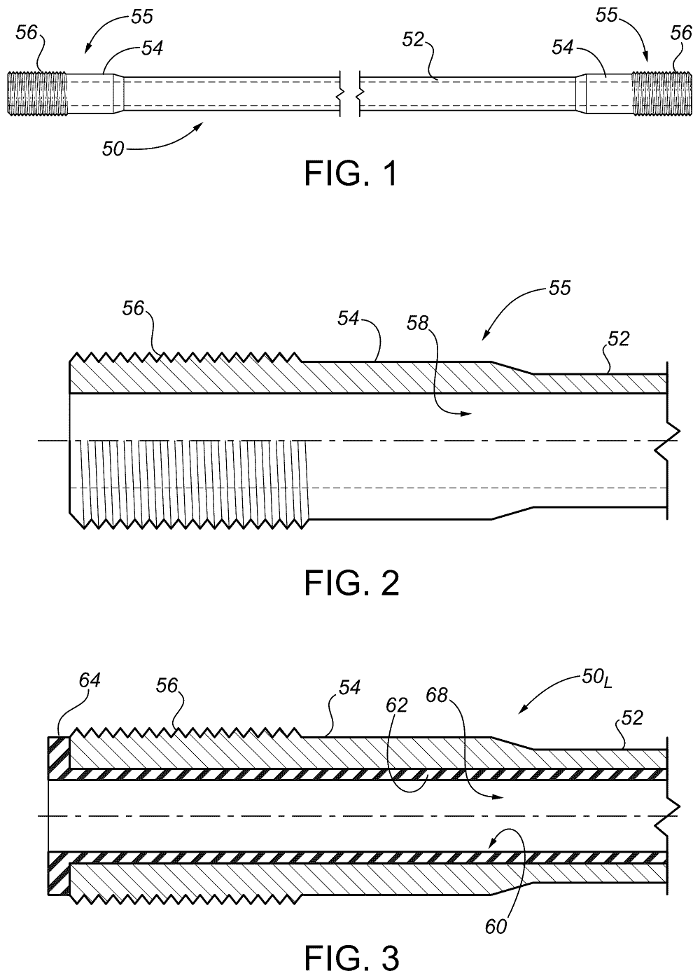

FIG. 1 is a side view of a prior art “upset” oilfield tubular having upset ends 55 and a main barrel section 52 extending between upset ends 55, with each upset end 55 having an externally-threaded end portion 56 (engageable with an internally-threaded coupling) and an unthreaded portion 54 extending between threaded end portion 56 and main barrel section 52, and with the outside diameter of unthreaded portions 54 of upset ends 55 being greater than the outside diameter of main barrel section 52. As shown in cross-section in FIG. 2, a longitudinal bore 58 extends the length of tubular 50.

FIG. 3 illustrates a lined upset oilfield tubular 50L generally the same as in FIGS. 1 and 2, but having a polymeric liner 60 extending through bore 58 of tubular 50L. Liner 60 has a main barrel section 62 extending between annular end flanges 64 that abut the end faces of upset ends 55 of tubular 50L, such that flanges 64 axially retain liner 60 within bore 58 of tubular 50L. It is at the annular junction of barrel section 62 and flanges 64 where liner 60 is particularly susceptible to tensile failure and fracture in freezing temperatures as discussed above.

Polyketones are thermoplastic materials that are known to have good high-temperature resistance. For this reason, the inventors chose to use polyketone to produce liners for lining oilfield tubulars for operating in high-temperature downhole environments. To visually distinguish the liners of their polyketone-lined tubing from the liners of lined tubing produced by others, the inventors decided to blend a coloring agent into a base polyketone resin (“Ketoprix EKR72 (M730R)”), and happened to select for this purpose a color concentrate referred to as “MBC 0116323 Blue PK” supplied by Badger Color Concentrates Inc. of Mukwonago, Wisconsin. The supplier's Technical Data Sheet for this color concentrate describes it as being provided in the form of approximately 3/32″× 3/32″ cylindrical pellets, and as consisting essentially of a base resin (specifically, “M730A Poketon Polyketone”) plus colorants and toners. The literature of its manufacturer (Hyosung, of South Korea) indicates that M730A Poketon Polyketone is a semi-crystalline polyketone, made of carbon monoxide (CO) and olefins.

Very unexpectedly, the inventors discovered that the resultant “blue” polyketone resin, containing about 1.5% to about 2.5% color concentrate by weight, exhibited better cold-weather performance than the polyketone resin without the color concentrate, while remaining readily extrudable to make tubular liners. In particular, the inventors unexpectedly discovered that liner flange breakage during sub-freezing-point temperatures was much less for liners made with the “blue” polyketone resin than for liners make with the same polyketone resin without any coloring agent. More specifically, flange breakage rates in the 0° F. to −20° F. (−18° C. and −29° C.) temperature range were observed to have been reduced to approximately 15% for liners made with the “blue” polyketone resin with a color concentrate content (or “dosage”) of 2% by weight; this represents a 75% to 78% reduction from the previously-observed flange breakage rates (i.e., 60% to 70%) for “plain” polyketone liners in the same temperature range.

The inventors tested “blue” polyketone liners having different color concentrate dosages, and observed that color concentrate dosages greater than approximately 2.5% by weight did not result in a significant further decrease in flange breakage rates in the 0° F. to −20° F. (−18° C. and −29° C.) temperature range, and in fact slowed down tubing production rates due to factors such as the need for more frequent production breaks to clean the liner extrusion equipment. The inventors also observed that color concentrate dosages less than approximately 1.5% by weight had comparatively limited apparent effect on liner flange breakage rates in the above-noted temperature range, with approximately 1% by weight being the lowest color concentrate dosage that appeared to have any discernible effect on liner breakage rates in that temperature range, and that effect was marginal at best.

Based on these tests and observations, the inventors concluded that the color concentrate dosage range having a practical beneficial effect at least with respect to liner flange breakage is from approximately 1% to approximately 2.5% by weight, with a color concentrate dosage of approximately 1.5% providing beneficial practical effects somewhat greater than provided by blends with a colorant content of approximately 1.0%, and with a color concentrate dosage of approximately 2% appearing to be a “sweet spot” that provides optimal practical benefits.

Although the reasons for the unexpected but clearly evident improvements in cold-weather performance provided by the “blue” polyketone resin blend over uncolored polyketone are not yet understood, it seems readily inferable that improvement is rooted in the inclusion of the color concentrate, as that is the only physical difference from the uncolored polyketone resin used by the inventors to produce the “plain” polyketone liners that are the reference point for the performance improvements observed with the “blue” polyketone liners. It also seems readily inferable that the color concentrate may have the technical effect, for reasons not presently known to the inventors, of increasing the cold-weather ductility of the base polyketone resin. However, whatever the technical cause for it may be, the observed improved cold-weather performance of the “blue” polyketone liners was clearly an unexpected result of the blending of the color concentrate into the base polyketone resin.

Although the inventors happened to choose a blue colorant, for reasons unrelated to cold-weather performance and without any reason to contemplate that addition of a coloring agent would cause the resultant polyketone resin blend to have physical properties different in any way from those of the base polyketone resin, the inventors consider it soundly predictable, in light of the beneficial changes evidently resulting from addition of the coloring agent, that blends of polyketone resin with coloring agents of other hues but of generally similar (though not necessarily identical) chemical composition as the “MBC 0116323 Blue PK” color concentrate should exhibit similar improved cold-weather performance as well, whether such alternative coloring agents are manufactured or supplied by Badger Color Concentrates Inc. or by a different manufacturer or supplier, and such alternative polyketone/colorant blends are intended to come within the scope of the present disclosure.

The inventors also consider it reasonable to predict that improved cold-weather performance may be provided by alternative polyketone/colorant blends that use colorant agents other than the “MBC 0116323 Blue PK” color concentrate but of generally similar (though not necessarily identical) chemical compositions, and such alternative polyketone/colorant blends are intended to come within the scope of the present disclosure.

As previously noted, Ketoprix EKR72 (M730R) was used as the base polyketone resin for the specific polyketone/colorant blends described herein. As described in its manufacturer's literature, Ketoprix EKR72 (M730R) resin is a thermoplastic aliphatic polyketone containing a 1,4-diketone backbone structure, produced from ethylene, propylene and carbon monoxide (CO) with perfectly alternating olefin and CO monomers in the backbone. The inventors consider it soundly predictable that polyketone/colorant blends similar to those specifically described herein but using made with a base polyketone different from but chemically generally similar to Ketoprix EKR72 (M730R) would exhibit similar improved cold-weather performance properties.

It will be readily appreciated by those skilled in the art that various modifications to embodiments in accordance with the present disclosure may be devised without departing from the present teachings, including modifications that may use materials later conceived or developed. It is to be especially understood that the scope of the present disclosure and claims should not be limited to or by any particular embodiments described and/or claimed herein, but should be given the broadest interpretation consistent with the disclosure as a whole. It is also to be understood that the substitution of a variant of a described or claimed element or feature, without any substantial resultant change in functionality, will not constitute a departure from the scope of the disclosure or claims.

In this patent document, any form of the word “comprise” is intended to be understood in a non-limiting sense, meaning that any element or feature following such word is included, but elements or features not specifically mentioned are not excluded. A reference to an element or feature by the indefinite article “a” does not exclude the possibility that more than one such element or feature is present, unless the context clearly requires that there be one and only one such element or feature.

What is claimed is:

1. A polyketone blend consisting essentially of a polyketone resin fraction and a coloring agent fraction.

2. The polyketone blend as in claim 1 wherein the polyketone resin fraction comprises a thermoplastic aliphatic polyketone containing a 1,4-diketone backbone structure, produced from ethylene, propylene and carbon monoxide (CO) with perfectly alternating olefin and CO monomers in the backbone.

3. The polyketone blend as in claim 1 wherein the coloring agent is a polyketone-based color concentrate consisting essentially of a polyketone resin and a colorant.

4. The polyketone blend as in claim 3 wherein the polyketone base of the color concentrate comprises a semi-crystalline polyketone made of carbon monoxide (CO) and olefins.

5. The polyketone blend as in claim 3 wherein the color concentrate is provided in the form of cylindrical pellets.

6. The polyketone blend as in claim 3 wherein the hue of the color concentrate is blue.

7. The polyketone blend as in claim 3 wherein the coloring agent fraction makes up approximately 1.0 to approximately 2.5 percent of the thermoplastic material by weight.

8. The polyketone blend as in claim 3 wherein the coloring agent fraction makes up approximately 1.5 to approximately 2.0 percent of the thermoplastic material by weight.

9. The polyketone blend as in claim 3 wherein the coloring agent fraction makes up approximately 2.0 percent of the thermoplastic material by weight.

10. A tubular liner extruded from a polyketone blend as in claim 1.

11. A lined oilfield tubular comprising:
(a) a steel tubular having a bore extending the length of the steel tubular; and
(b) a tubular liner as in claim 10 disposed within and extending through the length of the bore of the steel tubular.

12. The lined oilfield tubular as in claim 11 wherein each end of the tubular liner forms an annular flange extending beyond and abutting an end face of the steel tubular.

13. The lined oilfield tubular as in claim 12 wherein the steel tubular is an upset steel tubular.
